(19) United States
(12) Patent Application Publication
(10) Pub. No.: US 2008/0308297 A1
(43) Pub. Date: Dec. 18, 2008

(54) Ubm Pad, Solder Contact and Methods for Creating a Solder Joint

(76) Inventors: Claudia Jurenka, Berlin (DE); Juergen Wolf, Berlin (DE); Gunter Engelmann, Berlin (DE); Herbert Reichl, Berlin (DE)

Correspondence Address: GLENN PATENT GROUP, 3475 EDISON WAY, SUITE L, MENLO PARK, CA, 94025, US

(21) Appl. No.: 11/915,128

(22) PCT Filed: May 19, 2006
(86) PCT No.: PCT/EP2006/004783

§ 371 Date: Jun. 19, 2008

(30) Foreign Application Priority Data
May 25, 2005 (DE) 10 2005 024 088.7
Oct. 28, 2005 (DE) 10 2005 051 857.5

(51) Int. Cl. H01B 5/00; B23K 31/02

(52) U.S. Cl. 174/126.2; 228/190

(57) ABSTRACT

A UBM pad has a first material layer which has a first material, and a second material layer which has a second material and represents an end layer or is arranged between an end layer and the first material layer. The first material and the second material exhibit properties with regard to a solder material that the presence of the second material prevents any metallurgical reactions of the first material with the solder material in the entire temperature range of connecting and of the operation of the structured electronic device which are detrimental to the reliability of the overall joint.

### TECHNICAL FIELD

The present invention relates to a UBM pad (UBM=under bump metallization) for a solder contact, to a solder contact and to a method for creating solder joints between a UBM pad and/or a solder contact and a further solder partner, in particular in the area of microelectronic bonding methods (flip chip connections).

### BACKGROUND

Flip chip connection is a common method for electrically and mechanically connecting an electric device, e.g. a semiconductor chip. To this end, so-called flip chip bumps (flip chip solder bumps) are utilized. These flip chip bumps are deposited on the electronic device (IC chip) or on a substrate. A chip is intended to mean an electronic component made of, for example, silicon (Si), silicon germanium (SiGe), gallium arsenide (GaAs) or indium phosphite (InP) or other materials. Here, the flip chip bumps serve both to mechanically attach the chip on the respective substrate carrier and to create an electric contact between the chip and/or the electronic component and the terminal pads on the substrate. Due to existing environmental protection provisions, there is the requirement to configure the flip chip bumps and/or solder bumps using lead-free compounds in the future. Thus, lead-free materials are increasingly used, e.g., on a substrate, a chip or any electronic device for flip chip technology.

Applying lead-free soldering in flip chip connection systems necessitates comprehensive skills in the area of under bump metallizations (UBMs), solder materials, metallizations as well as with regard to the interactions between these components. Common UBMs eligible for this are implemented and tested with various lead-free soldering systems so as to examine the formation and growth of intermetallic compounds (IMCs) with regard to their reliability. Due to the metallurgical reaction of the materials and the formation of the IMCs associated therewith, standard UBMs based on Cu are not suitable for lead-free applications at elevated temperatures, for devices having very small solder joints. It is the subject-matter of the invention to describe a UBM architecture which comprises a limited and/or controlled formation of IMCs at the interface between the UBM layers and the solder.

FIG. 6 shows the architecture of a conventional bump 11. The conventional bump structure 11 includes a UBM layer, or under bump metallization layer 20, consisting of an adhesion and diffusion barrier layer 21 and a solder wetting layer 23, and a solder 25.

The architecture of a substrate 13 and/or of the chips which are in a wafer assembly is as shown in FIG. 6: the surface is protected by a passivation 19 and supports a relatively large number of terminal pads 17, wherein the passivation is opened, and which represent the electrical connection to the outside. The adhesion and diffusion barrier layer 21 is deposited on the terminal pads 17 and on the passivation 19. Thus, the adhesion and diffusion barrier layer 21 is connected to the terminal pads 17 in an electrically conducting manner. The solder wetting layer 23 is deposited on the adhesion and diffusion barrier layer 21, while the solder 25 is deposited on the wetting layer 23.

The adhesion and diffusion barrier layer 21, the wetting layer 23 and the solder 25 are deposited, for example, onto terminal contacts and/or aluminum I/O pads of ICs in the wafer assembly. The solder 25 is electrodeposited, for example, by suitable methods, whereas the UBM layers 20 are deposited, for example, by means of sputtering and/or electrodeposition. Parts of the UBM layers 20 may serve as an electrode in the subsequent galvanic process so as to reinforce the wetting layer 23. The reinforcement is implemented as a one-layer metallization. The UBM layers 20 are employed as adhesion layers and diffusion barriers and as wetting areas for the solder 25. At the same time, UBM layers 20 perform a technological function in depositing the solder 25, or the solder bumps, onto a wafer by means of physical or chemical and/or electro-chemical processes. There are a multitude of possibilities of implementing the UBM layer 20 and/or the UBM configuration. Currently there are highly different UBM configurations, depending on the manufacturer.

Depending on the bump material, different under bump metallization systems and/or UBM layers 20 are used. The materials used are, for example, a layer system of chrome, copper and gold (Cr/Cu/Au), a layer system of chrome, a chrome/copper compound and copper (Cr/CrCu/Cu), a layer system of a compound of titanium, tungsten and copper with copper (TiWCu—Cu), a layer system of nickel, possibly with vanadium and copper (Ni/Cu and/or NiV/Cu), a layer system of titanium and nickel, possibly with phosphorous (Ti/Ni and/or Ti/NiP), a layer system of a compound of titanium and tungsten with a compound of nickel and vanadium (TiW—NiV), a layers system of aluminum, nickel (Ni, NiP) and gold (Al/Ni/Au and/or Al/NiP/Au), a layer system of titanium, a compound of titanium and nickel, with an alloy of copper and nickel (Ti/TiNi/Cu—Ni), a layer system of titanium, nickel and palladium (Ti/Ni/Pd), or a layer system of nickel, possibly with phosphorous, palladium and gold (Ni/Pd/Au and/or NiP/Pd/Au). The solder may be implemented as a tin/copper solder (Sn—Cu), tin/silver (Sn—Ag), tin/gold (Sn—Au), tin/zinc (Sn—Zn), tin/lead (Sn—Pb), tin/bismuth (Sn—Bi) or tin/indium (Sn—In) mixtures.

The adhesion and diffusion barrier layer 21 is implemented, for example, from chrome (Cr), a chrome/copper mixture (Cr—Cu mixture and/or Cr—Cu compound), titanium (Ti), a compound of titanium and tungsten (TiW), a compound of titanium, tungsten and nitrogen (TiWN) or from aluminum (Al).

In a metallurgical reaction of the wetting layer 23 with the solder, 25 which occurs, for example, in a reflow process, the so-called intermetallic compounds (IMC) are formed due to direct and indirect influence of heat. These intermetallic compounds influence the reliability of the metallurgical overall architecture of a solder joint. Under certain circumstances, the contact may become brittle, and thus the solder joints may delaminate and the electrical contact may be lost. The amount of growth of the intermetallic compound is highly dependent on the selection of the metal layer systems and/or on the configuration of the UBM layer 23 and of the solder 25. As a consequence of the change in the interface energy due to the increased proportion of tin (e.g. in comparison with PbSn), the use of lead-free solder joints, such as compounds consisting of tin (Sn), of tin and silver (SnAg), of tin, silver and copper (SnAgₓCu_{y}) or of tin and copper (SnCu) may lead to a reaction with the underlying metal layers which is intensified accordingly. The wetting layer 23 implemented, for example, from a copper material of a thickness of, e.g., about 5 um, may be fully consumed in the process.

With small bump sizes, a limitation of the growth of intermetallic compounds (IMCs) due to the UBM solder reaction is crucial for increasing the reliability of electrical connections. There are several possibilities of slowing down the process of the formation of IMCs occurring, for example, during liquid and solid phase reactions between UBM and lead-free solder. UBM materials exhibiting slower formation of IMCs than other materials, as is true for Ni in comparison with Cu. In this case, the process of UBM consumption is slowed down but it is not stopped.

The reliability of a single-layer UBM (e.g. Ni, Cu) may be improved by increasing the layer thickness of the UBM. For realizing bumps, it is also possible to use solder alloys which slow down the UBM consumption. For solder contacts having a height of, e.g., 60 μm to 80 μm and having a suitable solder alloy, the Al/Ni(V)/Cu UBM has proven itself as a potential UBM for lead-free solders. The thin-film Al/Ni(V)Cu UBM, however, is not successfully employed with lead-free solders if the Cu proportion of the latter is not sufficiently high.

### SUMMARY

According to an embodiment, a UBM pad for a solder contact may have a first material layer which comprises a first material, a second material layer which comprises a second material and which itself represents an end layer or is arranged between an end layer and the first material layer, wherein the first material and the second material exhibiting such characteristics with regard to a solder material that the presence of the second material prevents any metallurgical reactions of the first material with the solder material in the entire temperature range of connecting and of operating the assembled electronic device which are detrimental to the reliability of the overall connection, wherein the solder material, the first material and the second material are such that in a metallurgical reaction, the second material and the solder material have higher rates of forming an intermetallic compound than the first material and the solder material; and that a proportion of the solder material in an intermetallic compound consisting of the second material and the solder material is smaller than a proportion of the solder material in an intermetallic compound consisting of the first material and the solder material would be; wherein the second material layer has a thickness which ensures that in a metallurgical reaction, such a layer of an intermetallic compound, which comprises the solder material and the second material, is formed between the solder material and the first material layer, so that the formation of an intermetallic compound consisting of the first material and the solder material does not occur.

An embodiment may have a solder contact using such a UBM pad which has a solder material arranged on the end layer.

According to another embodiment, a method for creating a solder joint using such a UBM pad may have the steps of creating the solder contact on a first solder partner, positioning a second solder partner on the solder contact, and performing reflow soldering, thermode bonding, diffusion soldering (solid phase reaction) or any other joining method for creating an intermetallic compound consisting of the second material and the solder material, and for joining the first and second solder partners.

According to another embodiment, a method of creating a solder joint between such a UBM pad and a solder partner comprising a solder material may have the steps of creating the UBM pad comprising the above-mentioned features, positioning the solder material of the solder partner on the UBM pad and performing reflow soldering, thermode bonding, diffusion soldering (solid phase reaction) or any other joining method for creating an intermetallic compound consisting of the second material and the solder material for joining the UBM pad and the solder partner.

An embodiment of the present invention provides a method of creating a solder contact consisting of a solder material and an under bump metallization layer (UBM) having a bilayer wetting structure, comprising a first layer of a first material and a second layer of a second material. The second wettable material layer is arranged between the solder material and the first wettable material layer, the solder material, the first material and the second material being of such kinds that, in a metallurgical reaction, the second material and the solder material exhibit a higher rate of forming an intermetallic compound than the first material and the solder material. Also, a proportion of the solder material in an intermetallic compound consisting of the second material and the solder material is smaller than a proportion of the solder material in an intermetallic compound consisting of the first material and the solder material. Moreover, the second under metallization layer comprises a thickness which ensures that in a metallurgical reaction, such a layer of an intermetallic compound consisting of the solder material and the second material is formed between the solder material and the first wettable material layer so that the formation of an intermetallic compound consisting of the first material and the solder material does not occur. The layer of the intermetallic compound is, e.g., almost continuous, so that the formation of an intermetallic compound consisting of the first material and the solder material does not occur.

Moreover, an embodiment of the present invention enables the implementation of a method of creating a solder joint using a solder contact having above-mentioned features on a first solder partner. This method includes positioning a second solder partner on the solder contact of said first solder partner, creating a reliable solder joint of the first and second solder partners, wherein an intermetallic compound consisting of the second wettable material and the solder material of the first solder partner is formed which prevents the consumption of the first wettable material of the first solder partner, as well as creating a suitable solder alloy during reflow.

An embodiment of the present invention is based on the findings that a second wettable material layer having predetermined properties and being arranged between a solder material and a first wettable material layer prevents or highly restricts the formation of an intermetallic compound consisting of a material of the first wettable material layer and the solder material.

An embodiment of the present invention provides a solder contact which may be realized, e.g., by physical-chemical processes such as sputtering, vaporizing and electrodeposition, as a multi-layer system of metals exhibiting differing metallurgical properties toward lead-free solder. By means of a suitable architecture and adequate selection of the individual layer thicknesses of these multi-metal layer systems it is possible to achieve a stable interface for solders, for example lead-free solders such as Sn, SnCu, SnAg, SnAg(x)Cu(y), with regard to an underlying metal system. By selecting suitable layer thickness and metallization systems, growth of the intermetallic compounds to be formed may be limited, restricted and/or stopped early on, so that no complete conversion of at least one of the wettable metallization layers, of the metallization facing a wafer and/or chip, i.e. facing away from the solder, into intermetallic compounds occurs during the operation of the components. In other words, complete conversion of at least one of the wettable metallization layers both during the liquid phase reaction in a re-melting process (e.g. reflow soldering) and during a solid phase reaction in the subsequent operation is to be prevented.

The dimensioning of the layer thicknesses is dependent on the solder volume necessary and on the solubility of the respective metal in the solder at the temperature at which the metallurgical reaction is performed. Respective data regarding solubility is known from the literature.

To simplify matters, with regard to UBM, the first material of the first wettable material layer will be referred to as M1 below, whereas the second material of the second wettable material layer will be referred to as M2. In addition, an intermetallic compound (intermetallic phase) of components of the solder and M1 will be referred to as IMC M1, and an intermetallic compound of components of the solder and M2 will be referred to as IMC M2.

In principle, both metallizations and/or materials M1 and M2 are capable of forming intermetallic compounds with the components of the solder. In accordance with an embodiment of the invention, the materials M1 and M2 are selected such that, in a metallurgical reaction, the second material and the solder material have a higher rate of formation and/or growth of an intermetallic compound than the first material and the solder material. The second material represents the material of the metallization layer which is directly exposed to and/or facing the solder. The formation and/or growth rate of IMC M2 thus is higher than that of IMC M1 during the liquid phase reaction (and/or during a solid phase reaction), so that M2 acts as a sacrificial layer during reflow soldering, is transformed into IMC M2 and is located between the solder and the underlying metallization M1. M2's property of exhibiting, in the conversion reaction with the solder, comparatively faster growth and/or faster formation of intermetallic compounds at the temperature at which the metallurgical reaction takes place may thus be used to achieve that the metallic compound to be formed results in an almost impermeable layer, so that the metallization of the first wettable material layer (M1) which is facing away from the solder is not in direct contact with the solder.

In accordance with an embodiment of the invention, that proportion of the components which originate from the solder is higher in an intermetallic compound resulting from a liquid phase reaction between M1 and solder than in the intermetallic compound resulting from a liquid phase reaction of M2 and solder. Thus, a creation of an intermetallic compound IMC M1 at an interface of IMC M2 with M1 may be prevented. Rather, material M2 may only be partly replaced by material M1 up to a certain saturation in the intermetallic compound IMC M2. The resulting ternary phase (3-phase system), however, still contributes to an almost closed separating layer.

The morphology of the intermetallic compound forming at the interface between wettable material layers and solder is dependent on the components involved in its formation and composition. The formation of the intermetallic compounds at the interface between wettable material layers and solder competes, during the liquid phase reaction, with the dissolution of the offered metallization in the solder. Due to this fact, what is to be considered in addition to the solubility of the metal M2 in the solder at the temperature during the reflow soldering is the morphology of the intermetallic compounds; in accordance with an embodiment of the invention, an intermetallic compound comprising the solder and M2 is to represent an almost impermeable layer between solder and M1, so that any reaction between these two components is prevented.

In accordance with an embodiment of the invention, the second wettable material layer comprises a thickness which ensures that, in a metallurgical reaction, a continuous layer of an intermetallic compound consisting of the solder material and the second material is formed between the solder material and the first material layer. The layer of the intermetallic compound may be formed to be largely continuous, so that only one intermetallic compound consisting of M2 and the solder is formed. The second wettable material layer which is to be transformed into one or more intermetallic compounds during reflow soldering is designed such that the ratio of its mass to the mass of the solder roughly corresponds to the solubility of its metal in the solder system, or is larger than that, specifically at the temperature at which reflow soldering takes place, i.e. during the reflowing of the solder. In the ideal case, a suitable selection of the layer thickness can ensure that only one intermetallic compound consisting off M2 and solder is formed.

In other words, for stabilizing the system, i.e. the solder contact after the reflow soldering, a closed layer of intermetallic compounds is achieved by the reflow soldering, in the formation of which M2 and components of the solder are primarily involved, i.e. the proportion of M1 in the intermetallic compound is smaller than or equal to the solubility maximum of M1 in the intermetallic compound of M2 and the components of the solder. Thus, this layer may cause a topological separation of solder and M1 so as to prevent, in the ideal case, direct conversion of M1 with components of the solder at temperatures during which the solder is present as a liquid phase, or to avoid direct contact of solder and M1 and to prevent solder from being supplied to M1. Thereby, during reflow soldering, the formation of intermetallic compounds made up mainly by M1 and components of the solder is prevented. In addition, during the operation of components, the intermetallic compound consisting of solder and M2 acts as a diffusion barrier, so that in the ideal case, formation and growth of new intermetallic compounds at the interface between the intermetallic compound and a non-converted metallization layer, may be prevented.

To enable the creation of a closed layer of intermetallic compounds of the type mentioned, the layer thicknesses of the metallizations involved, and primarily the layer thickness of the sacrificial layer, are to be adapted to the solder volume and to the solder composition. A target thickness may be defined as a thickness wherein the ratio of the mass of the metallization M2 to the mass of the solder, based on the ratios present at a bump, corresponds to the solubility maximum of M2 in the solder at the maximum temperature achieved during the reflow soldering in the bump.

In the embodiment, the first material exhibited by the first wettable material layer is nickel, whereas the second material exhibited by the second wettable material layer is copper. Sn or alloys of the SnAg and CuSn systems may be employed as the solder. As an alternative to the lead-free solder systems mentioned for which an embodiment of the present invention may be advantageously used, it is also possible to employ the UBM system developed also for non-lead-free solder systems, for example PbSn.

The inventive multi-layer UBM system may be realized by combining physical, electrochemical and/or chemical processes. In the embodiments of the invention, the multi-UBM layers are created by sputtering and electrodeposition. The inventive multi-layer UBM system is not limited to two wettable material layers. There may be more than two wettable material layers involved, which result in adequate stabilization. The first wettable material layer is that wettable material layer which is most remote from the solder material, the layers arranged therebetween having the properties described above with regard to the second wettable material layer. In addition, any of the layers may comprise those properties—with regard to the respectively adjacent layer which is more remote from the solder material—that have been described above with regard to the second and first wettable material layers.

As has been described above, the architecture of the UBM system and, in particular, the selection of the thickness of the second wettable material layer is to be adjusted, accordingly, to the solder mass and thus to the size of the bumps and the solder composition. What is crucial here is the ratio of the solder mass to the mass of the material of the second wettable material layer, which is copper in the embodiment. As an adhesion layer between the solder contact and a terminal pad arranged on a substrate, thin-layer systems, such as Ni:V, Ti, Cr, CrCu and others, may be employed. What is of significance for embodiments of the invention is the multi-layer system exposed to the solder, which in embodiments of the invention is the bilayer of Ni and Cu.

The inventive UBM system is applicable to the assembly, i.e. soldering, of electronic components and semiconductor chips using small and thin contact systems. The principle is basically applicable to all solder joints even outside of flip chip bonding, but is employed in semiconductor and Microsystems technology.

The inventive UBM architecture allows numerous improvements and advantages. One example of what is achieved is a process-compatible realization of a stable interface, i.e. of a stable contact pad, in under bump metallization for lead-free solder joints for flip chip assembly of semiconductor devices, generally in so-called wafer processing. The reliability of the contact system is increased by reducing and stabilizing the formation of compounds at the interface between solder and under bump metallization. In addition, an adjustment to various lead-free solder systems, e.g. to different solder alloys such as SnAg, SnCu, etc., may be effected by varying the layer thicknesses of the multi-layer UBM system. By means of suitable layer-thickness ratios, the solder composition itself, e.g. SnₓCu_{y}, may also be influenced. The adjustment of the solder composition which is due to the architecture avoids high-effort processes for realizing and checking solder alloy depositions, such as SnₓCu_{y}, and/or completely replaces them. This may contribute to a cost reduction while simultaneously increasing the reliability of flip chip contact systems. In addition, an embodiment of the present invention allows cost benefits to be achieved in wafer bumping by reduced process times (smaller layer thicknesses) while simultaneously increasing the reliability by means of a stabilized contact pad.

An embodiment of the invention is of particular significance for those cases of application wherein a multiplicity of small solder contacts (e.g. microsensor systems, 3D integration in microelectronics) are employed.

### BRIEF DESCRIPTION OF THE DRAWINGS

Embodiments of the present invention will be explained below in more detail with reference to the accompanying figures, wherein:

FIG. 1 shows a bump structure in accordance with an embodiment of the present invention;

FIG. 2 shows a schematic view of a solder contact in accordance with an embodiment of the present invention following a liquid phase reaction, wherein a partial layer of the second wettable material layer has remained;

FIG. 3 shows a schematic view of a solder contact in accordance with a further embodiment of the present invention following a liquid phase reaction, wherein the entire second wettable material layer has been converted to a (continuous) intermetallic layer;

FIG. 4 shows a schematic view of a solder contact with too thin a second wettable material layer following a liquid phase reaction;

FIG. 5 depicts a UBM pad as a solder partner for a solder bump (corresponds to FIG. 1 without solder); and

FIG. 6 depicts a conventional bump structure.

### DETAILED DESCRIPTION

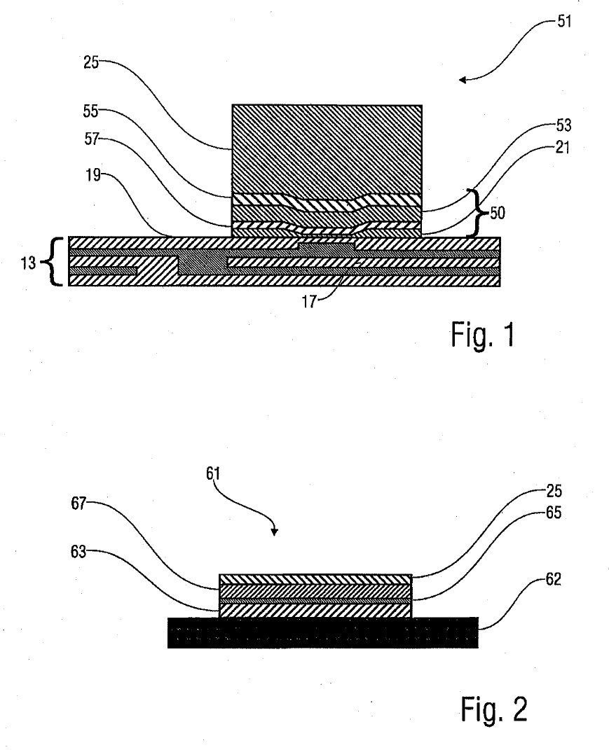

FIG. 1 shows a bump structure 51 in accordance with an embodiment of the present invention on substrate 13. In the description of the embodiments which follows, identical elements, or elements having identical actions, will be given identical reference numerals. In particular, elements which are identical to, or have identical actions as those of FIG. 6, will be provided with same reference numerals. The following description of the embodiment shown in FIG. 1 is limited to a representation of the differences as compared to the architecture of FIG. 6.

Bump structure 51 in accordance with an embodiment of the present invention differs from the conventional bump structure 11 particularly in that a wettable bilayer consisting of a first material layer 53 and a second material layer 55 is provided instead of a material layer 23. In addition, an optional electrodeposition starting layer 57 is arranged between the adhesion and diffusion barrier layer 21 and the first wettable material layer 53 in FIG. 1. The inventive bump structure may be located both on a semiconductor wafer (FIG. 1) and on any other carrier substrate (silicon, circuit board, glass, foil, ceramic, etc.).

The UBM 50 (multi-layer system consisting of metal and/or metal layers) which is shown here and consists of adhesion and diffusion barrier layer 21, electrodeposition starting layer 57, first wettable material layer 53 and second wettable material layer 55 may be created, for example, by physical-chemical processes such as sputtering or galvanic processes, the various metal layers exhibiting various metallurgical characteristics toward solder 25. Solder 25 may be configured to be lead-free. The electrodeposition starting layer 57 is optional and is provided when the first wettable material layer 53 is created by a galvanic process.

By suitable selection of the layer thicknesses and the materials in the metallization system and/or of the materials of the first wettable material layer 53 and the second wettable material layer 55, growth of the forming intermetallic compound consisting of the material of the first wettable material layer 53 and the solder material in a metallurgic reaction may be prevented. A material of the second wettable material layer 55 exhibits a faster formation of intermetallic compounds in the liquid phase reaction than one of the materials of the first wettable material layer 53. As has already been explained above, a conversion of the material of the first wettable material layer 53 with the solder is prevented by means of an intermetallic compound consisting of a material of the second wettable material layer 55 and the solder material. In the application example, this intermetallic compound forms an almost impermeable layer.

The UBM architecture 50 shown in FIG. 1 and/or the bump structure 51 shown in FIG. 1, in accordance with an embodiment of the present invention thus enables a solder contact to be configured which is stable with regard to phase growth, specifically when using lead-free soldering, and which may be employed in a fast and economical manner—in process terms—for wafer bumping of semiconductors and electronic components.

The bump structure 51 shown in FIG. 1 may be used for connecting the solder partner shown here to a further solder partner. To this end, the second solder partner, not shown here, is positioned at the solder contact and/or at the bump structure 51, and reflow soldering is subsequently performed, so that an intermetallic compound consisting of the second material and the solder material is formed, and so that the solder partner shown here is connected to the other solder partner. The method is possibly conducted such that the step of performing the reflow soldering is performed for a predetermined period of time at a predetermined temperature, so that a continuous and/or largely continuous layer of an intermetallic compound consisting of the second material and the second wettable material layer 55 and the solder material 25 is formed, and so that no intermetallic compound consisting of the first material in the first wettable material layer 53 and the solder material 25 is formed.

FIG. 2 shows a schematic view of a solder contact 61 after performing a metallurgical reaction, in accordance with an embodiment of the present invention, the solder contact having been formed by means of reflow soldering of a layer arrangement consisting of a first wettable material layer, a second wettable material layer and a solder material. The second material layer has such a thickness that following the metallurgical reaction, the first material layer 63 is arranged on a substrate having an adhesion and diffusion barrier layer and electrodeposition starting layer 62, part 65 of the second material layer having remained on said first material layer 63. This partial layer 65 has an intermetallic compound 67 arranged thereon which was formed by means of a metallurgical reaction of the material of the second material layer 65 with the solder.

In the solder contact shown in FIG. 2, the second wettable material layer had such a large layer thickness, prior to the metallurgical reaction, that same was not completely consumed in the metallurgical reaction, and the partial layer 65 remains. Thus, the intermetallic compound 67 merely consists merely of a compound consisting of the material of the second material layer and the solder material. If the second material layer consists of copper, and if the solder material consists of tin, a Cu₆Sn₅ compound will result. An intermetallic compound consisting of the first wettable material layer and the solder material (which is Ni₃Sn₄ in the case of nickel and tin) cannot be formed, so that a reliable solder contact is obtained.

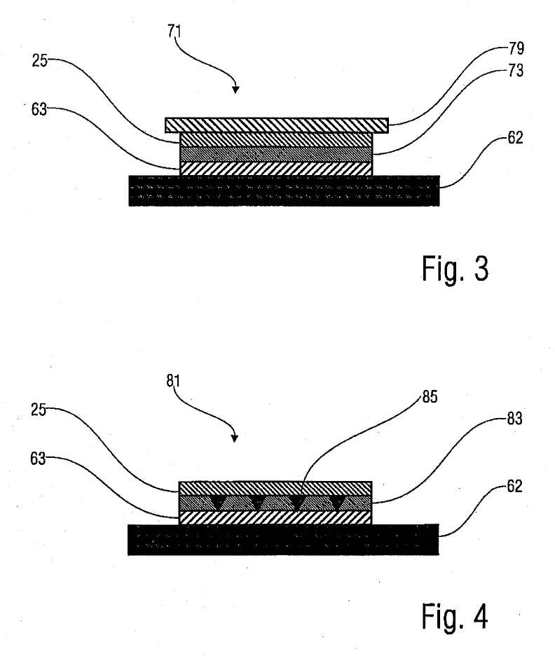

FIG. 3 shows a schematic view of a solder contact 71 after performing a metallurgical reaction at an elevated temperature, in accordance with a further embodiment of the present invention, the solder contact 71 having been formed by means of reflow soldering of a layer arrangement of a first wettable material layer, a second wettable material layer, and the solder material. The second material layer had such a thickness that in the liquid phase reaction, the second material layer was completely consumed, and such that an intermetallic compound 73, IMC M2 is arranged between the solder layer 25 and the first material layer 63.

Since, in accordance with the invention, the solder proportion in the intermetallic compound 73 is smaller than it would be in an intermetallic compound IMC M1 consisting of the first material layer 63 M1 and the solder material, such an intermetallic compound IMC M1 is not created at the interface between IMC M2 and M1. Depending on the materials used, there is rather an exchange, at the interface between IMC M2 and M1, of M2 and M1 in the intermetallic compound IMC M2 up to a certain saturation value.

If M1 is nickel, M2 is copper and the solder material is tin, the intermetallic compound will form as a (Cu, Ni)₆Sn₅ layer.

The embodiment shown in FIG. 3 enables utilization of a thinner second wettable material layer 2 than the example shown in FIG. 2, it still being possible to ensure reliable solder contact. FIG. 3 further schematically represents a second solder partner 79 connected to the substrate 62 by means of the reflow soldering. Both solder partners may be, for example, electronic devices, integrated circuits or substrates.

FIG. 4 depicts a comparative example 81 after performing reflow soldering, wherein the second wettable material layer exhibited too large a thickness. As is shown in FIG. 4, no continuous layer of an intermetallic compound 83 forms between the material of the second material layer and the solder material 25, but said layer 83 is traversed by solder needles 85 which reach up to the wettable material layer 63, M1. Thus, the solder reaches up to the first material layer 63 so that an intermetallic compound IMC M1 may be formed there, which results in that reliability of the solder contact is no longer guaranteed.

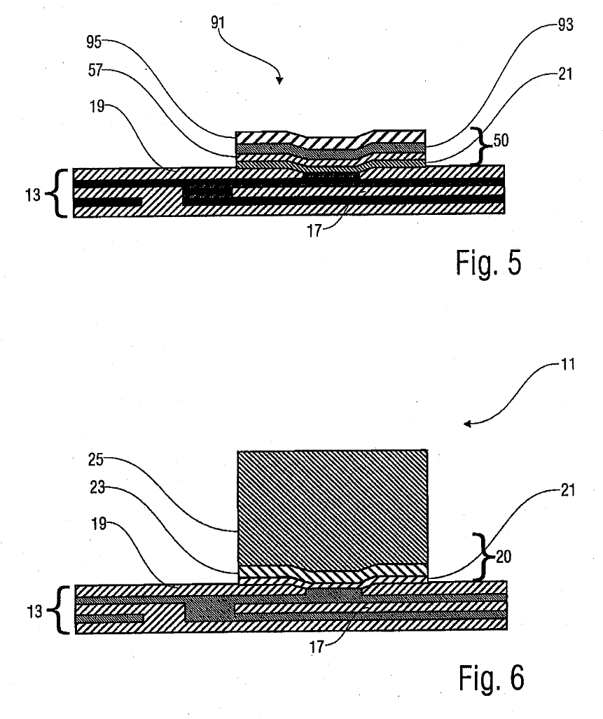

FIG. 5 shows a UBM pad and/or terminal contact 91 in accordance with an embodiment of the present invention. Unlike the bump structure shown in FIG. 1, no solder material 25 is present in the UBM pad 91, and a first wettable material layer is designated by reference numeral 93, and a second wettable material layer by reference numeral 95. Via UBM pad 91, an electrical and/or mechanical connection to a solder partner which is not shown here is established. A solder material, not shown here, is located on a solder contact on the solder partner.

The present invention was examined using an implementation wherein a system as has been shown in FIG. 1 was used. A TiW layer which was deposited by sputtering and is therefore referred to as TiWₛₚ was used as the adhesion and diffusion barrier layer 57. As the electrodeposition starting layer 21, a Cu layer Cuₛₚ was deposited by sputtering. In succession, a nickel layer Niₑₚ was deposited as the first wettable material layer 53, and a copper layer Niₑₚ was deposited as the second wettable material layer 55 onto the electrodeposition starting layer 21.

Sn, an SnAg alloy and a eutectic SnCu alloy were used as the solder material. Small Sn bumps of a height of 23 μm formed the focus of attention of the evaluation. The nickel layer Niₑₚ comprised a thickness of 1.5 μm. In a first example, a copper layer Cuₑₚ of a thickness of 150 nm was used, whereas in a second example, a copper layer Cuₑₚ of a thickness of 500 nm was used. A Cu layer thickness of 500 nm represents the upper limit of the solubility of Cu in Sn with this bump height (23 μm Sn) during the reflow soldering. Soldering is conducted at a temperature of 250° C. The respective solubility may be read from the phase diagram according to U. R. Kattner et al. (Z. Metallkd., Vol 92, No. 7, July 2001, pages 740 to 746). If a Cu layer having a thickness of 150 nm were completely dissolved in Sn, this would correspond to the eutectic composition.

The solder bumps which are structured accordingly were subjected to aging, prior to which they had been subject to reflow for 120 s at 250° C. (liquid phase reaction). The subsequent thermal aging (solid phase reaction) was performed at 150° C. for up to 1000 h.

On the basis of the described metallization scheme TiWₛₚCuₛₚ—Niₑₚ—Cuₑₚ as under-metallization and Sn as solder, a stable interface between Ni and solder was achieved by forming the intermetallic compound (CuNi)₆Sn₅. (CuNi)₆Sn₅ is formed by converting Cu, if it is present in a sufficient amount in the boundary layer (optimized Cu layer thickness), and solder in the liquid phase reaction. During the subsequent thermal aging, no change in the interface was found that would represent an adverse effect on the contact.

By contrast, a comparative example with too thin a Cu layer revealed that in the longer term there is a complete, if slowed-down, consumption of the first material layer M1 consisting of nickel.

The studies conducted are published in “Effect of the Cu Thickness on the Stability of a Ni/Cu Bilayer UBM of Lead Free Microbumps during Liquid and Solid State Aging”, by C. Jurenka Wolf, Engelmann, Reichl et al., 55^{th} Electronic Components & Technology Conference (ECTC 2005), Lake Buena Vista, Fla. (USA), May 31-Jun. 3, 2005, Proc. pages 89-93. Said article describes that with a suitable selection of the layer thickness of the second material layer of Cu, a nearly continuous separating layer consisting of (Cu, Ni)₆Sn₅ is generated between solder and nickel, the composition of said layer not having changed during the subsequent thermal aging. This composition is dependent on the duration of the reflow process, on the temperature selected and on the dimensioning of the layer thicknesses.

The first wettable material layer 53 and the second wettable material layer 55 may be deposited, for example, by means of sputter processes, vapor processes or other galvanic, or electrochemical, processes (FIG. 1). However, the present invention is not limited to such methods for depositing the first material layer 53 and the second material layer 55, it being possible to employ any other methods desired. The solder may be deposited, for example, by means of galvanic processes, vapor-deposition processing, solder paste pressure or by means of placing solder preforms (e.g. solder balls). In the above embodiments, two material layers 53 and 55 (FIG. 1) are arranged, in bump structure 51, between solder material and adhesion layer. However, a larger number of material layers whose properties with regard to the first material layer are comparable to that of the second material layer may be arranged between the first material layer and the solder.

In the above embodiments, specific layer thicknesses adjusted to the reflow solder temperature, materials and solder material mass have been used. Depending on the circumstances, however, other layer thicknesses may be employed as long as it remains ensured that a separating layer of the type described will form between one of the wettable material layers and the solder. In the above embodiments, the bump structure 51 in accordance with the present invention is employed to implement flip chip bondings. However, utilizing a metallization which corresponds to the bump structure 51 in any manner desired is a further application thereof.

Instead of using nickel and copper for the first and second wettable material layers, any suitable metals or metal layer systems or metal alloys may be used which mutually exhibit the properties defined.

The adhesion and diffusion barrier layer and the electrodeposition starting layer may each comprise different layer thicknesses. In the field of application of microelectronics, these typically are in the range of a few nanometers. The thickness of the first wettable material layer is uncritical, and in this field of application it is within a range of several micrometers (typically 1-100 μm). The second wettable material layer may exhibit a layer thickness in a range of several nanometers up to several micrometers. To be able to implement a layer architecture with as small a thickness as possible (reduced process times), the thickness of the second material layer is smaller than the thickness of the first material layer. In individual cases, the layer thicknesses specifically of the second material layer 2 must be adjusted to the solder volume and thus to the bump size.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A UBM pad for a solder contact, comprising:
a first material layer which comprises a first material; and
a second material layer which comprises a second material and which itself represents an end layer or is arranged between an end layer and the first material layer;
the first material and the second material exhibiting such characteristics with regard to a solder material that the presence of the second material prevents any metallurgical reactions of the first material with the solder material in the entire temperature range of connecting and of operating the assembled electronic device which are which are detrimental to the reliability of the overall joint,
wherein the solder material, the first material and the second material are such
that in a metallurgical reaction, the second material and the solder material comprise higher rates of forming an intermetallic compound than the first material and the solder material; and
that a proportion of the solder material in an intermetallic compound including the second material and the solder material is smaller than a proportion of the solder material in an intermetallic compound including the first material and the solder material would be;
wherein the second material layer comprises a thickness which ensures that in a metallurgical reaction, such a layer of an intermetallic compound, which comprises the solder material and the second material, is formed between the solder material and the first material layer, so that the formation of an intermetallic compound including the first material and the solder material does not occur.

2. The UBM pad as claimed in claim 1, wherein the first material comprises nickel.

3. The UBM pad as claimed in claim 1, wherein the second material comprises copper.

4. The UBM pad as claimed in claim 1, wherein the solder material comprises tin or a tin alloy.

5. The UBM pad as claimed in claim 1, wherein the second material layer is thinner than the first material layer.

6. The UBM pad as claimed in claim 1, wherein the thickness of the second material layer is such that, when the technological manufacturing tolerances are taken into account, the solubility maximum of this second material in the solder is reliably achieved at the maximum temperature reached during the overall process.

7. The UBM pad as claimed in claim 1, comprising an adhesion and diffusion barrier layer, the adhesion and diffusion barrier layer being arranged on that side of the first material layer which is facing away from the second material layer.

8. The UBM pad as claimed in claim 7, wherein the adhesion and diffusion barrier layer comprises a layer thickness below 1 μm.

9. The UBM pad as claimed in claim 1, wherein a plurality of material layers are arranged between the solder material and the first material layer.

10. The UBM pad as claimed in claim 1, which further comprises an electrodeposition starting layer on a side of the first material layer which is facing away from the second material layer.

11. The UBM pad as claimed in claim 1, comprising a terminal pad, the terminal pad being connected to the first material layer in an electrically conducting manner, and the first material layer being arranged between the terminal pad and the second material layer.

12. A solder contact comprising a UBM pad for a solder contact, comprising: a first material layer which comprises a first material; and a second material layer which comprises a second material and which itself represents an end layer or is arranged between an end layer and the first material layer; the first material and the second material exhibiting such characteristics with regard to a solder material that the presence of the second material prevents any metallurgical reactions of the first material with the solder material in the entire temperature range of connecting and of operating the assembled electronic device which are which are detrimental to the reliability of the overall joint, wherein the solder material, the first material and the second material are such that in a metallurgical reaction, the second material and the solder material comprise higher rates of forming an intermetallic compound than the first material and the solder material; and that a proportion of the solder material in an intermetallic compound including the second material and the solder material is smaller than a proportion of the solder material in an intermetallic compound including the first material and the solder material would be; wherein the second material layer comprises a thickness which ensures that in a metallurgical reaction, such a layer of an intermetallic compound, which comprises the solder material and the second material, is formed between the solder material and the first material layer, so that the formation of an intermetallic compound including the first material and the solder material does not occur, comprising a solder material arranged on the end layer.

13. The solder contact as claimed in claim 12, wherein a solder partner comprises the solder material.

14. A method of creating a solder joint using a solder contact comprising a UBM pad for a solder contact, comprising: a first material layer which comprises a first material; and a second material layer which comprises a second material and which itself represents an end layer or is arranged between an end layer and the first material layer; the first material and the second material exhibiting such characteristics with regard to a solder material that the presence of the second material prevents any metallurgical reactions of the first material with the solder material in the entire temperature range of connecting and of operating the assembled electronic device which are which are detrimental to the reliability of the overall joint, wherein the solder material, the first material and the second material are such that in a metallurgical reaction, the second material and the solder material comprise higher rates of forming an intermetallic compound than the first material and the solder material; and that a proportion of the solder material in an intermetallic compound including the second material and the solder material is smaller than a proportion of the solder material in an intermetallic compound including the first material and the solder material would be; wherein the second material layer comprises a thickness which ensures that in a metallurgical reaction, such a layer of an intermetallic compound, which comprises the solder material and the second material, is formed between the solder material and the first material layer, so that the formation of an intermetallic compound including the first material and the solder material does not occur, comprising a solder material arranged on the end layer, the method comprising:
creating the solder contact, on a first solder partner;
positioning a second solder partner on the solder contact; and
performing reflow soldering, thermode bonding, diffusion soldering (solid phase reaction) or any other joining method for creating an intermetallic compound including the second material and the solder material, and for joining the first and second solder partners.

15. A method of creating a solder joint between a UBM pad for a solder contact, comprising: a first material layer which comprises a first material; and a second material layer which comprises a second material and which itself represents an end layer or is arranged between an end layer and the first material layer; the first material and the second material exhibiting such characteristics with regard to a solder material that the presence of the second material prevents any metallurgical reactions of the first material with the solder material in the entire temperature range of connecting and of operating the assembled electronic device which are which are detrimental to the reliability of the overall joint, wherein the solder material, the first material and the second material are such that in a metallurgical reaction, the second material and the solder material comprise higher rates of forming an intermetallic compound than the first material and the solder material; and that a proportion of the solder material in an intermetallic compound including the second material and the solder material is smaller than a proportion of the solder material in an intermetallic compound including the first material and the solder material would be; wherein the second material layer comprises a thickness which ensures that in a metallurgical reaction, such a layer of an intermetallic compound, which comprises the solder material and the second material, is formed between the solder material and the first material layer, so that the formation of an intermetallic compound including the first material and the solder material does not occur and a solder partner comprising a solder material, the method comprising:
creating the UBM pad;
positioning the solder material of the solder partner on the UBM pad; and
performing reflow soldering, thermode bonding, diffusion soldering (solid phase reaction) or any other joining method for creating an intermetallic compound including the second material and the solder material for joining the UBM pad and the solder partner.

16. The method as claimed in claim 14, wherein the step of joining is performed over a predetermined time period at a predetermined temperature such that a nearly continuous layer of an intermetallic compound including the second material and the solder material is formed, and no intermetallic compound including the first material and the solder material is formed.

17. The method as claimed in claim 15, wherein the step of joining is performed over a predetermined time period at a predetermined temperature such that a nearly continuous layer of an intermetallic compound including the second material and the solder material is formed, and no intermetallic compound including the first material and the solder material is formed.
